(19) United States
(12) Patent Application Publication
(10) Pub. No.: US 2021/0078433 A1
(43) Pub. Date: Mar. 18, 2021

(54) CHARGING MANAGEMENT DEVICE FOR ELECTRIC VEHICLE, CHARGING SYSTEM HAVING THE SAME, AND CHARGING METHOD FOR ELECTRIC VEHICLE

(71) Applicants: HYUNDAI MOTOR COMPANY, SEOUL (KR); KIA MOTORS CORPORATION, SEOUL (KR)

(72) Inventor: Jungmin CHA, Hwaseong-si (KR)

(73) Assignees: HYUNDAI MOTOR COMPANY, SEOUL (KR); KIA MOTORS CORPORATION, SEOUL (KR)

(21) Appl. No.: 16/735,227

(22) Filed: Jan. 6, 2020

(30) Foreign Application Priority Data
Sep. 16, 2019 (KR) 10-2019-0113397

(51) Int. Cl. B60L 53/66; B60L 53/62; B60L 53/18

(52) U.S. Cl. CPC B60L 53/665; B60L 53/18; B60L 53/62

(57) ABSTRACT

A charging method for an electric vehicle includes: receiving, by a charging management device, charging request data from a charging target vehicle; searching, by the charging management device, for a charging providing vehicle sharing electric power with the charging target vehicle in response to the charging request data to generate vehicle information data regarding the charging providing vehicle; transmitting, by the charging management device, the vehicle information data to the charging target vehicle; checking, by the charging management device, charging result data received from the charging target vehicle or the charging providing vehicle; generating, by the charging management device, payment request data based on the charging result data; and transmitting, by the charging management device, the payment request data to the charging target vehicle.

### CROSS-REFERENCE TO RELATED APPLICATION

The present application claims priority to and the benefit of Korean Patent Application No. 10-2019-0113397 filed on Sep. 16, 2019, which is incorporated herein by reference in its entirety.

### TECHNICAL FIELD

The present disclosure relates to a charging method for an electric vehicle, and more particularly, to a charging management device for an electric vehicle, a charging system having the charging management device, and a charging method for the electric vehicle capable of charging the electric vehicle by receiving electric power from another vehicle when charging for the electric vehicle is not performed in a charging station.

### BACKGROUND

The statements in this section merely provide background information related to the present disclosure and may not constitute prior art.

Recently, interest in environmental issues, particularly global warming and a climate change have been increased, many countries have discussed the implementation of a climate change convention on reduction of carbon dioxide emissions, and in this discussion, it has been pointed out that an increase of carbon dioxide generation causes the global warming, and an exhaust gas exhausted from a vehicle is a main cause of the increase of carbon dioxide.

According to a carbon emission control policy, fuel efficiency of a vehicle based on a fossil fuel in the vehicle industry should be increased and carbon emission of the vehicle should be reduced. Thus, a vehicle using environmentally friendly energy has been developed to replace the vehicle based on the fossil fuel.

The environmentally-friendly vehicle such as a hybrid electric vehicle (HEV) using both a fossil fuel and electricity and an electric vehicle (EV) using only electricity is being developed.

The electric vehicle receives electrical energy from the outside to charge a battery so that the vehicle is driven by a driving motor that is coupled with a driving wheel and uses a voltage charged in the battery.

The electric vehicle includes the driving motor that drives the vehicle and is an electric motor and a battery for supplying electricity to the electric motor.

Charging of the electric vehicle includes slow charging, medium speed charging, and rapid charging. Generally, a time required for full charging of the battery is 6 hours or more in case of the slow charging, a time required for full charging of the battery is 2-3 hours in case of the medium speed charging, and a time required for full charging of the battery is about 1 hour in case of the rapid charging. Thus, it takes a long time to charge the electric vehicle.

In addition, there is not enough charging station to charge the electric vehicle at present so that the vehicle has to travel long distances to arrive at a charging station. If there aren't many chargers in the charging station, it will take a long time to charge the electric vehicle.

### SUMMARY

The present disclosure provides a charging management device for an electric vehicle, a charging system having the same, and a charging method for the electric vehicle capable of sharing electric power with another vehicle.

Further, the present disclosure provides the charging management device for the electric vehicle, the charging system, and the charging method capable of performing payment for charging of the electric vehicle.

One form of the present disclosure may provide the charging method for the electric vehicle, including: receiving, by a charging management device, charging request data from a charging target vehicle; searching, by the charging management device, for a charging providing vehicle sharing electric power with the charging target vehicle in response to the charging request data to generate vehicle information data regarding the charging providing vehicle; transmitting, by the charging management device, the vehicle information data to the charging target vehicle; checking, by the charging management device, charging result data received from the charging target vehicle or the charging providing vehicle; generating, by the charging management device, payment request data based on the charging result data; and transmitting, by the charging management device, the payment request data to the charging target vehicle.

The receiving the charging request data may include: receiving, by the charging management device, the charging request data including a position where the charging target vehicle is expected to park and a charging amount required by a battery of the charging target vehicle, from the charging target vehicle.

The generating the vehicle information data regarding the charging providing vehicle may include: searching, by the charging management device, for vehicle management data; determining, by the charging management device, whether there is the charging providing vehicle that provides the charging amount required by the battery to the charging target vehicle and is located at the position where the charging target vehicle is expected to park, based on the vehicle management data; and generating, by the charging management device, the vehicle information data regarding the charging providing vehicle when there is the charging providing vehicle that provides the charging amount required by the battery.

The generating the vehicle information data regarding the charging providing vehicle may include: generating, by the charging management device, the vehicle information data including at least one of a vehicle type, a vehicle number, a parking location, an installation location of a charging/discharging device, charging/discharging port information, and wireless charging/discharging link information regarding the charging providing vehicle.

The generating the vehicle information data regarding the charging providing vehicle may include: transmitting, by the charging management device, charging providing query data to a communication device for the charge providing vehicle; receiving, by the charging management device, charging providing response data from the communication device; checking, by the charging management device, whether an approval is included in the charge providing response data; and generating, by the charging management device, the vehicle information data regarding the charging providing vehicle when the charging providing response data includes the approval.

The checking the charging result data may include: receiving, by the charging management device, first charging result data including at least one of a charging amount and a charging time from the charging target vehicle to check the first charging result data.

The checking the charging result data further may further include: receiving, by the charging management device, second charging result data including at least one of a discharging amount and a discharging time from the charging providing vehicle to check the second charging result data.

The generating the payment request data may include: generating, by the charging management device, a payment charge based on the charging result data; and generating, by the charging management device, the payment request data including the payment charge.

The generating the payment charge may include: searching, by the charging management device, for charge data including a charging unit price; and generating, by the charging management device, the payment charge using the charge data and the charging result data.

Another form of the present disclosure may provide the charging management device for the electric vehicle, including: a receiver configured to receive charging request data and charging result data from a charging target vehicle; an information generator configured to search for a charging providing vehicle sharing electric power with the charging target vehicle based on the charging request data to generate vehicle information data regarding the charging providing vehicle; a controller configured to generate a payment charge based on the charging result data and charge data and to generate payment request data including the payment charge; and a transmitter configured to transmit the vehicle information data and payment request data to the charging target vehicle.

The information generator may be configured to search for vehicle management data matching identification information of a vehicle including the charging target vehicle and the charging providing vehicle and a remaining amount of a battery of the vehicle with location data of the vehicle and to check the charging providing vehicle that provides a charging amount required by the battery of the charging target vehicle and is located at a position where the charging target vehicle is expected to park based on the vehicle management data. The position where the charging target vehicle is expected to park and the charging amount required by the battery of the charging target vehicle may be included in the charging request data.

The information generator may be configured to generate the vehicle information data including at least one of a vehicle type, a vehicle number, a parking location, an installation location of a charging/discharging device, charging/discharging port information, and wireless charging/discharging link information regarding the charging providing vehicle.

The controller may be configured to generate an identification code based on the payment charge and to generate the payment request data including the identification code.

The identification code may include at least one of a radio frequency identification tag, a near field communication tag, a one-dimensional barcode, and a two-dimensional barcode.

Another form of the present disclosure may provide the charging system for the electric vehicle, including: a charging target vehicle configured to generate charging request data including a position where the charging target vehicle is expected to park and a charging amount required by a battery of the charging target vehicle; a charging providing vehicle configured to transmit electric power to the charging target vehicle; and a charging management device configured to search for the charging providing vehicle sharing the electric power with the charging target vehicle in response to the charging request data to generate vehicle information data regarding the charging providing vehicle, transmit the vehicle information data to the charging target vehicle, generate payment request data based on charging result data, and transmit the payment request data to the charging target vehicle.

The charging target vehicle may be configured to receive the electric power from the charging providing vehicle through a wired cable.

A wireless charging receiver of the charging target vehicle may be configured to receive the electric power from a wireless charging transmitter of the charging providing vehicle.

The charging management device may be configured to search for vehicle management data matching identification information of a vehicle including the charging target vehicle and the charging providing vehicle and a remaining amount of a battery of the vehicle with location data of the vehicle and to check the charging providing vehicle that provides the charging amount required by the battery of the charging target vehicle and is located at the position where the charging target vehicle is expected to park based on the vehicle management data.

The charging management device may be configured to search for a third party vehicle providing the charging amount required by the battery of the charging target vehicle if there is no vehicle to share the electric power with the charging target vehicle in the position where the charging target vehicle is expected to park.

The charging management device may be configured to generate a payment charge based on the charging result data including at least one of a charging amount and a charging time of the charging target vehicle and a discharging amount and a discharging time of the charging providing vehicle and to generate the payment request data including the payment charge.

The charging management device for the electric vehicle, the charging system, and the charging method in some forms of the present disclosure may charge the electric vehicle by receiving electric power from another vehicle. Thus, in order to charge the vehicle, it is not necessary to search for a charging station to go to the charging station or to wait at the charging station when there aren't many chargers in the charging station.

Further, some forms of the present disclosure may perform payment for charging of the electric vehicle. Thus, some forms of the present disclosure may generate revenue of a driver having the vehicle that supplies electric power.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a configuration diagram showing a charging system for an electric vehicle in one form of the present disclosure.

FIG. 2A and FIG. 2B are exemplary diagrams showing a charging target vehicle and a charging providing vehicle in one form of the present disclosure.

FIG. 3 is a block diagram showing a charging management device for the electric vehicle in one form of the present disclosure.

FIG. 4 and FIG. 5 are flowcharts showing a charging method for the electric vehicle in one form of the present disclosure.

FIG. 6 is an exemplary diagram for explaining the charging method in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Further, in describing some forms of the present disclosure, the related well-known functions or constructions will not be described in detail since they may unnecessarily obscure the understanding some forms of the present disclosure. Further, the following terminologies are defined in consideration of the functions in some forms of the present disclosure and may be construed in different ways by the intention of users and operators, practice, or the like. Therefore, the definitions thereof should be construed based on the contents throughout the specification.

Further, to effectively describe core technical features of the present disclosure, terms may be appropriately changed, integrated, or separated for those skilled in the art in a technical field to which the present disclosure belongs to explicitly understand the present disclosure, but the present disclosure is not limited thereto.

Hereinafter, some forms of the present disclosure will be described in detail with reference to the accompanying drawings.

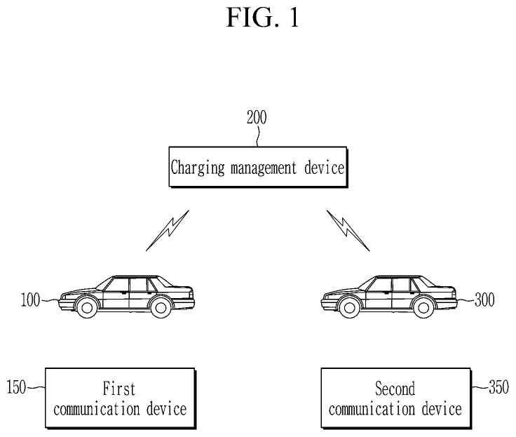

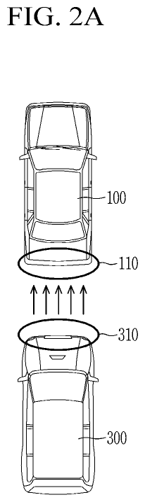

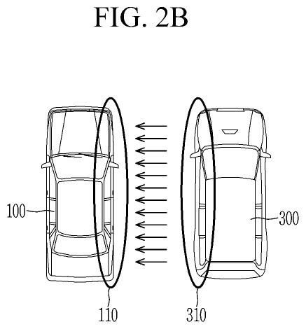

FIG. 1 is a configuration diagram showing a charging system for an electric vehicle in some forms of the present disclosure. FIGS. 2A and 2B are exemplary diagrams showing a charging target vehicle and a charging providing vehicle in some forms of the present disclosure.

Referring to FIG. 1, the charging system may include the charging target vehicle or a vehicle to be charged (e.g., an electric vehicle) 100, a first communication device or a first communication terminal 150, a charging management device 200 for the electric vehicle, the charging providing vehicle (e.g., an electric vehicle) 300, and a second communication device or a second communication terminal 350.

The charging target vehicle 100 may be a vehicle requesting charging due to insufficient battery remaining amount. The charging target vehicle 100 may be a vehicle subscribed to a charging sharing service. The charging sharing service may represent a service that shares electric power with another vehicle using a vehicle-to-vehicle (V2V) communication.

The charging target vehicle 100 may receive electric power from the charging providing vehicle 300 by wire or wirelessly.

For example, when the charging target vehicle 100 is a vehicle for wireless charging, the charging target vehicle may receive an electric power using a wireless charging receiver that is installed at least one of a side portion, a front portion, and a rear portion of the vehicle. The wireless charging receiver may be a wireless charging power receiver or a wireless charging pad that receives electric power wirelessly.

When the charging target vehicle 100 is a vehicle for wired charging, the charging target vehicle may be connected to the charging providing vehicle 300 through a wired cable to receive electric power from the charging providing vehicle 300.

The first communication device 150 may transmit and receive data with the charging management device 200 through a wireless communication. The first communication device 150 may generate charging request data to request charging.

The charging request data may include charging identification information, vehicle location, and a required amount of charging. The charge identification information may represent information that identifies the vehicle to perform charging, and may include a vehicle number, an identification (ID) number of a driver of the vehicle subscribed to the charging sharing service, and a mobile communication device number of the driver. The vehicle location may indicate a position where the charging target vehicle 100 is expected to park. The required amount of charging may represent a charging amount required by a battery driving the charging target vehicle and may be expressed as a state of charge (SOC) (%) or charging electric power (kW) of the battery driving the vehicle.

The first communication device 150 may receive payment request data from the charging management device 200 after charging of the vehicle 100, and may perform payment for the charging based on the payment request data. The first communication device 150 may pay through a credit card, bank transfer, or near field communication (NFC) payment based on the payment request data.

The first communication device 150 may be present or included in the charging target vehicle 100 or may be carried by a driver of the charging target vehicle. For example, the first communication device 150 may be an audio video navigation (AVN) device or a telematics device subscribed to a mobile service such as a blue link service or an UVO service that is installed inside the vehicle 100. The first communication device 150 may be a wearable device such as a smart watch or a handheld including a mobile communication device (e.g., a smart phone), a tablet personal computer (PC), or a netbook that is possessed by the driver.

The charging management device 200 may receive the charging request data from the first communication device 150 for the charging target vehicle 100, and may search for the charging providing vehicle 300 to share electric power with the charging target vehicle 100 based on the charging request data. For example, the charging management device 200 may a telematics server.

The charging management device 200 may generate charging providing query data to inquire whether a driver of the charging providing vehicle 300 shares electric power. The charging management device 200 may transmit the charging providing query data to the second communication device 350.

The charging management device 200 may generate vehicle information data for the charging providing vehicle 300 and may transmit the generated vehicle information data to the first communication device 150.

The charging management device 200 may receive charging result data from the charging target vehicle 100 or the charging providing vehicle 300, and may generate a payment charge based on the received charging result data. The charging result data may include at least one of a final charging amount (or a charging amount) and a charging time of the charging target vehicle 100 and a discharging amount and a charging providing time (or a discharging time) of the charging providing vehicle 300.

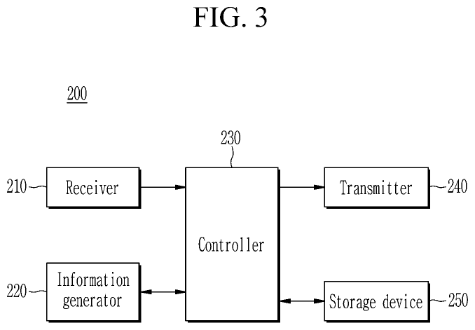

The charging management device 200 will be described in more detail with reference to FIG. 3.

The charging providing vehicle 300 may be a vehicle that shares electric power. The charging providing vehicle 300 may be a vehicle subscribed to the charging sharing service.

The charging providing vehicle 300 may provide electric power to the charging target vehicle 100 by wire or wirelessly.

When the charging providing vehicle 300 is a vehicle for wireless charging, the charging providing vehicle may transmit an electric power using a wireless charging transmitter that is installed at least one of a side portion, a front portion, and a rear portion of the vehicle. The wireless charging transmitter may be a wireless charging power transmitter or a wireless charging pad that transmits electric power wirelessly.

For example, as shown in FIG. 2A, the charging providing vehicle 300 including the wireless charging transmitter 310 that is installed in the front portion of the charging providing vehicle may transmit electric power to the wireless charging receiver 110 installed in the rear portion of the charging target vehicle 100.

As shown in FIG. 2B, the charging providing vehicle 300 including the wireless charging transmitter 310 that is installed in a left side portion of the charging providing vehicle may transmit electric power to the wireless charging receiver 110 installed in a right side portion of the charging target vehicle 100.

When the charging providing vehicle 300 is a vehicle for wired charging, the charging providing vehicle may be connected to the charging target vehicle 100 via the wired cable to transmit the electric power to the charging target vehicle 100.

The second communication device 350 may transmit and receive data with the charging management device 200 through a wireless communication network. The second communication device 350 may receive the charging providing query data from the charging management device 200. The second communication device 350 may display the charging providing query data, and may receive approval from the driver of the charging providing vehicle 300 to generate charging providing response data. The second communication device 350 may transmit the charging providing response data to the charging management device 200.

The second communication device 350 may be present or included in the charging providing vehicle 300 or may be carried by the driver of the charging providing vehicle. For example, the second communication device 350 may be an audio video navigation (AVN) device or a telematics device subscribed to the mobile service such as the blue link service or the UVO service that is installed inside the vehicle 300. The second communication device 350 may be a wearable device such as a smart watch or a handheld including a mobile communication device (e.g., a smart phone), a tablet personal computer (PC), or a netbook that is possessed by the driver

FIG. 3 is a block diagram showing the charging management device for the electric vehicle in some forms of the present disclosure.

Referring to FIG. 3, the charging management device 200 may include a receiver 210, an information generator 220, a controller 230, a transmitter 240 and a storage device 250.

The receiver 210 may be connected with the charging target vehicle 100 and the charging providing vehicle 300 through wireless communication, and may receive data from the charging target vehicle 100 and the charging providing vehicle 300.

The receiver 210 may receive the charging request data and first charging result data from the charging target vehicle 100.

The receiver 210 may receive the charging providing response data and second charging result data (or discharging result data) from the charging providing vehicle 300.

The information generator 220 may search for a vehicle or the charging providing vehicle 300 to share electric power with the charging target vehicle 100 to generate information on the searched vehicle.

In other words, the information generator 220 may check the charging request data received through the receiver 210. The information generator 220 may search for or detect the charging providing vehicle 300 to share electric power with the charging target vehicle 100 in response to the charging request data.

The information generator 220 may generate the charging providing query data.

The information generator 220 may generate the vehicle information data on the charging providing vehicle 300. The vehicle information data may include at least one of a vehicle type, a vehicle number, a parking location, an installation location of a charging/discharging device, charging/discharging port information, and wireless charging/discharging link information. The parking position may indicate a position where the charging providing vehicle 300 parks. The installation location of the charging/discharging device may indicate a location where the wireless charging transmitter is installed in the charging providing vehicle 300. For example, if the wireless charging transmitter is installed at the front portion of the charging providing vehicle 300, the installation location of the charging/discharging device may be the front portion. The charging/discharging port information may include a location of a charging/discharging port of the charging providing vehicle 300 and information for opening a lid or a door for the charging/discharging port. For example, the information for opening the lid may be a password required to open the lid. The wireless charging/discharging link information may indicate link information necessary for performing wireless charging/discharging in the charging providing vehicle 300.

The controller 230 may control the receiver 210, the information generator 220, the transmitter 240, and the storage device 250 of the charging management device 200 to share the electric power between the charging providing vehicle 300 and the charging target vehicle 100.

The controller 230 may generate the payment request data for requesting a payment charge for charging of the charging target vehicle 100 using the charging result data.

In other words, the controller 230 may check the first charging result data received from the charging target vehicle 100 or the second charging result data (e.g., the discharging result data) received from the charging providing vehicle 300.

The controller 230 may generate the payment charge based on the first charging result data (or the second charging result data) and charge data. The charge data may include a charging unit price for performing payment for charging of the charging target vehicle 100.

The controller 230 may generate the payment request data including the payment charge. The controller 230 may control or operate the transmitter 240 so that the transmitter transmits the payment request data to the charging target vehicle 300.

The transmitter 240 may connect with the charging target vehicle 100 and the charging providing vehicle 300 to transmit data to the charging target vehicle and the charging providing vehicle.

That is, the transmitter 240 may transmit the vehicle information data to the charging target vehicle 100. The transmitter 240 may transmit the payment request data to the charging target vehicle 100.

The transmitter 240 may transmit the charging providing query data from the information generator 220 to the charging providing vehicle 300.

The storage device 250 may store data required by an element (e.g., the information generator 220) of the charging management device 200 and data generated by the element.

For example, the storage device 250 may store the charging request data and the charging result data received through the receiver 210. The storage device 250 may store vehicle management data required by the information generator 220 and the vehicle information data generated by the information generator.

The storage device 250 may store the charge data required by the controller 230 and the payment request data generated by the controller.

The storage device 250 may store various programs for controlling an overall operation of the charging management device 200. The storage device 250 may provide data required according to a request of the receiver 210, the information generator 220, and the controller 230.

Although the storage device 250 is described as an example formed in the charging management device 200, the present disclosure is not limited thereto and the storage device may be formed separately from the charging management device 200.

The charging management device 200 may be implemented as at least one microprocessor operating by a program. The program may include a series of commands for executing a charging method for the electric vehicle in some forms of the present disclosure described below.

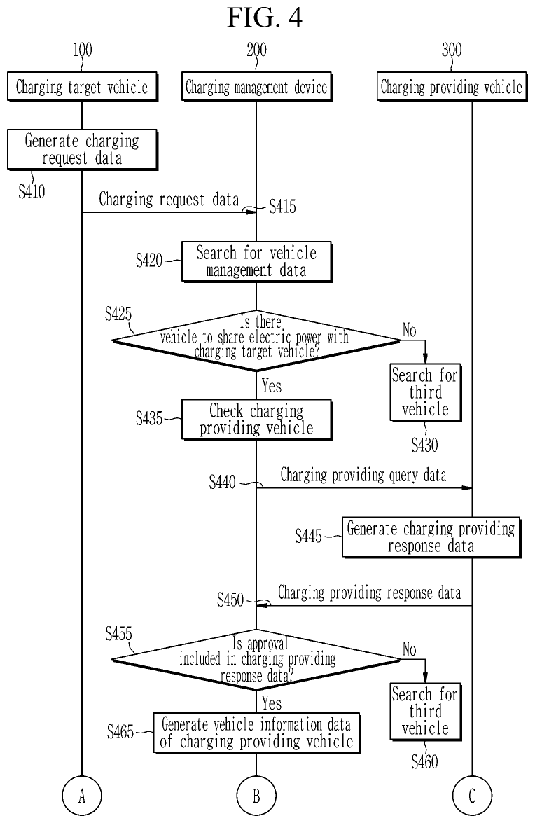

The charging method for the electric vehicle will be described in more detail with reference to FIG. 4 through FIG. 6. The elements of the charging management device 200 may be integrated or subdivided. Therefore, in the following description of the charging method in some forms of the present disclosure, the subject or a main agent of each step will be described as the charging management device 200.

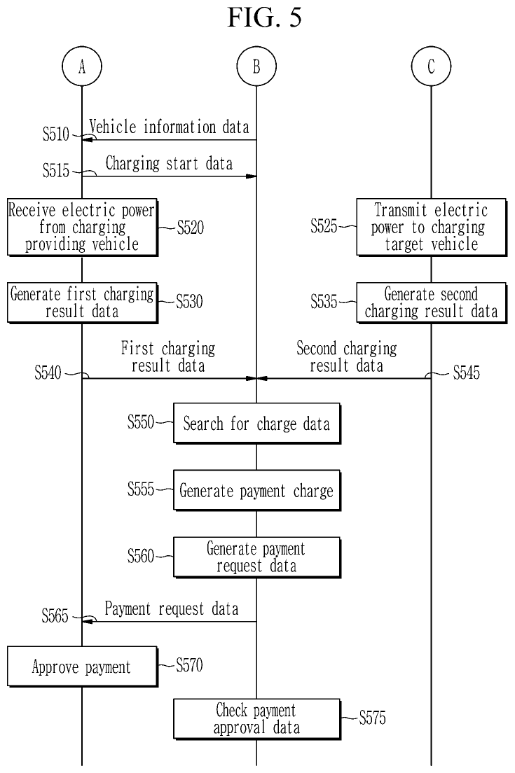

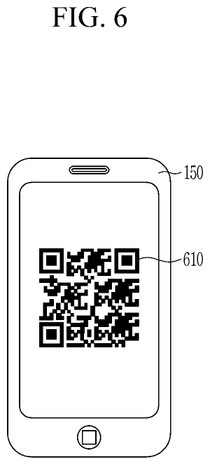

FIGS. 4 and 5 are flowcharts showing the charging method for the electric vehicle in some forms of the present disclosure. FIG. 6 is an exemplary diagram for explaining the charging method in some forms of the present disclosure.

Referring to FIGS. 4 and 5, the charging target vehicle 100 may generate the charging request data to request charging of the vehicle in step S410. In more detail, the charging target vehicle 100 may determine whether the driver of the vehicle subscribes to the charging sharing service when the driver requests the charging of the vehicle. If the charging target vehicle 100 is subscribed to the charge sharing service, the charging target vehicle may determine whether an available charger exists around the vehicle location. The location of the vehicle may indicate a position where the charging target vehicle 100 is expected to park and may be confirmed by a destination input to the first communication device 150 by the driver.

If the available charger does not exist around the vehicle location, the charging target vehicle 100 may generate the charging request data including the vehicle location and the required amount of charging. The required amount of charging may be expressed as the state of charge (SOC) or the charging electric power of the battery of the vehicle 100. The required amount of charging may be set by an input of the driver using the first communication device 150 or may be set by the charging target vehicle 100 checking a remaining amount of the battery.

The charging target vehicle 100 may transmit the charging request data to the charging management device 200 in step S415.

The charging management device 200 may search for or check the vehicle management data in step S420. The vehicle management data may be data for managing the vehicle subscribed to the charging sharing service. The vehicle management data may be stored by matching identification information of the vehicle and a remaining amount of the battery with location data of the vehicle subscribed to the charging sharing service. The location data may indicate a last location of the vehicle subscribed to the charging sharing service and may be a parked location of the vehicle. The vehicle identification information may be information for identifying the vehicle, and may include a vehicle model and a vehicle number. The remaining amount of the battery may represent a remaining battery amount of the battery of the vehicle.

For example, a plurality of vehicles subscribed to the charging sharing service may transmit location data of the vehicles, vehicle identification information, and battery remaining amount to the charging management device 200 before the vehicles are turned off. The charging management device 200 may generate and manage the vehicle management data by matching the vehicle identification information and the battery remaining amount with the location data.

The charging management device 200 may determine or check whether there is a vehicle to share electric power with the charging target vehicle 100 based on the vehicle management data in step S425.

In other words, the charging management device 200 may check the vehicle location and the required amount of charging included in the charging request data. The charging management device 200 may determine whether there is the vehicle 300 that is capable of providing the required amount of charging to the charging target vehicle 100 and is one among a plurality of vehicles located at the vehicle location, based on the vehicle management data.

The charging management device 200 may search for or check a third vehicle or a third party vehicle if there is no vehicle to share the electric power with the charging target vehicle 100 in a position where the charging target vehicle 100 is expected to park in step S430. That is, the charging management device 200 may search for the third party vehicle that is located at a position other than the expected parking position of the charging target vehicle 100 and provides the required amount of charging based on the vehicle management data. The third party vehicle may be a vehicle owned by an operator managing the charging sharing service, or may be a vehicle that is located at a position other than the expected parking position of the charging target vehicle 100 and is subscribed to the charging sharing service.

The charging management device 200 may check the charging providing vehicle 300 which is capable of providing the required amount of charging to the charging target vehicle 100 and is one among a plurality of vehicles located at the vehicle location based on the vehicle management data in step S435.

The charging management device 200 may transmit the charging providing query data to the charging providing vehicle 300 in step S440. In other words, the charging management device 200 may generate the charging providing query data to ask the driver of the charging providing vehicle 300 to share electric power. The charging management device 200 may transmit the charging providing query data to the second communication device 350 owned by the driver of the charge providing vehicle 300.

The second communication device 350 for the charging providing vehicle 300 may generate the charging providing response data in response to the charging providing query data in step S445. That is, the second communication device 350 may display the charging providing query data and may receive a response to the charging providing query data from the driver of the charging providing vehicle 300 to generate the charging providing response data. For example, when the driver of the charging providing vehicle 300 approves charging for the charging target vehicle 100, the second communication device 350 may generate the charging providing response data including the approval. When the driver rejects charging for the charging target vehicle 100, the second communication device 350 may generate the charging providing response data including the rejection.

The second communication device 350 for the charging providing vehicle 300 may transmit the charging providing response data to the charging management device 200 in step S450.

The charging management device 200 may check or determine whether the approval is included in the charge providing response data in step S455.

The charging management device 200 may search for or check the third party vehicle when the charging providing response data does not include the approval in step S460.

When the charging providing response data includes the approval, the charging management device 200 may generate the vehicle information data of the charging providing vehicle 300 in step S465. The vehicle information data may be data necessary for the charging target vehicle 100 to share electric power with the charging providing vehicle 300, and may include at least one of the vehicle type, the vehicle number, the parking location, the installation location of the charging/discharging device, the charging/discharging port information, and the wireless charging/discharging link information.

The charging management device 200 may transmit the vehicle information data to the charging target vehicle 100 in step S510. At this time, the charging management device 200 may transmit the vehicle information data to the first communication device 150 for the charging target vehicle 100. The first communication device 150 may display the vehicle information data provided from the charging management device 200 and may inform the driver of the charging target vehicle 100. Then, the driver of the vehicle 100 may perform work in order to receive electric power from the charging providing vehicle 300 based on the vehicle information data. For example, in a case of the wired charging, the driver of the vehicle 100 may perform work in order to receive the electric power by connecting the vehicle 100 to the charging providing vehicle 300 through the wired cable. In a case of the wireless charging, the driver of the vehicle 100 may move the charging target vehicle 100 so that the wireless charging receiver of the vehicle 100 corresponds to the wireless charging transmitter of the charging providing vehicle 300.

When the charging starts, the vehicle 100 may transmit charging start data to the charging management device 200 in step S515. The charging start data may be data for notifying the charging management device 200 of the start of the charging.

The charging target vehicle 100 may receive the electric power from the charging providing vehicle 300 in step S520. The charging target vehicle 100 may receive the electric power from the charging providing vehicle 300 through wireless communication or wired communication.

The charging providing vehicle 300 may transmit the electric power to the charging target vehicle 100 in step S525.

The charging target vehicle 100 may generate the first charging result data in step S530. That is, the charging target vehicle 100 may generate the final charging amount by checking or measuring an amount of charging in the battery after completing the charging, and may generate the charging time by checking or measuring a time for receiving the electric power from the charging providing vehicle 300. The charging target vehicle 100 may generate the first charging result data including at least one of the final charging amount and the charging time.

The charging providing vehicle 300 may generate the second charging result data in step S535. That is, the charging providing vehicle 300 may generate the discharging amount by checking or measuring an amount of discharging in a battery driving of the vehicle 300 after transmitting the electric power to the charging target vehicle 100, and may generate the discharging time by checking or measuring a time of transmitting the electric power to the charging target vehicle 100. The charging providing vehicle 300 may generate the second charging result data that includes at least one of the discharging amount and the discharging time.

The charging target vehicle 100 may transmit the first charging result data to the charging management device 200 in step S540.

The charging providing vehicle 300 may transmit the second charging result data to the charging management device 200 in step S545.

Although the charging management device 200 is described as an example that the charging result data is received from the charging target vehicle 100 and the charging providing vehicle 300, the present disclosure is not limited thereto. For example, the charging management device 200 may receive the charging result data from the charging target vehicle 100 or may receive the charging result data from the charging providing vehicle 300.

The charging management device 200 may search for or check the charge data including the charging unit price in step S550. The charge data may be preset as predetermined data in order to perform payment for charging of the charging target vehicle 100. The charge data may be set differently depending on a charging time zone of the battery or a season in which the battery is charged.

The charging management device 200 may generate the payment charge using the charge data and the charging result data in step S555.

In other words, the charging management device 200 may check the final charging amount and the charging time included in the first charging result data and the discharging amount and the discharging time included in the second charging result data. The charging management device 200 may check an amount of charging in the battery based on the charging time included in the charging result data.

The charging management device 200 may generate the payment charge based on the charging amount and the charge data.

The charging management device 200 may generate the payment request data including the payment charge in step S560. In other words, the charging management device 200 may generate an identification code based on the payment charge. The identification code may be data required for the driver of the charging target vehicle 100 to perform payment. For example, the identification code may be at least one of a radio frequency identification (RFID) tag, a near field communication (NFC) tag, a one-dimensional barcode, and a two-dimensional barcode. The two-dimensional barcode may be at least one of a quick response (QR) code, a maxi code, a data matrix code, and a PDF417.

The charging management device 200 may generate the payment request data including the identification code to request a payment to the charging target vehicle 100.

The charging management device 200 may transmit the payment request data to the first communication device 150 for the charging target vehicle 100 in step S565. The first communication device 150 may receive the payment request data from the charging management device 200 and may display the received payment request data. For example, as shown in FIG. 6, the first communication device 150 may display the payment request data including the identification code 610.

The first communication device 150 for the charging target vehicle 100 may approve the payment using the payment request data in step S570. For example, the first communication device 150 may approve the payment through a payment means (e.g., a credit card payment, a bank transfer, or a near field communication (NFC) payment) selected by the driver based on the payment request data.

The charging management device 200 may check payment approval data indicating that payment for the charging is completed in step S575. The payment approval data may be data for notifying that the first communication device 150 has approved the payment, and may be provided by a payment server. The payment server may be a server managing the payment means selected by the driver. For example, if the driver selects a bank as the payment means, the payment server may be a bank server.

It has been described as an example that the payment is performed after the charging is completed, but the present disclosure is not limited thereto. For example, the charging management device 200 may receive a payment means from the first communication device 150 when the charging starts, and may perform payment for the charging amount after the charging is completed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

### DESCRIPTION OF SYMBOLS

100: charging target vehicle
150: first communication device
200: charging management device
210: receiver
220: information generator
230: controller
240: transmitter
250: storage device
300: charging providing vehicle
350: second communication device

What is claimed is:

1. A charging method for an electric vehicle, comprising:
receiving, by a charging management device, charging request data from a charging target vehicle;
searching, by the charging management device, for a charging providing vehicle sharing an electric power with the charging target vehicle in response to the charging request data;
generating, by the charging management device, vehicle information data regarding the charging providing vehicle;
transmitting, by the charging management device, the vehicle information data to the charging target vehicle;
checking, by the charging management device, charging result data received from the charging target vehicle or the charging providing vehicle;
generating, by the charging management device, payment request data based on the charging result data; and
transmitting, by the charging management device, the payment request data to the charging target vehicle.

2. The charging method of claim 1, wherein receiving the charging request data further comprises:
receiving, by the charging management device, the charging request data from the charging target vehicle, wherein the charging request data comprises a position that the charging target vehicle is expected to park and a charging amount required by a battery of the charging target vehicle.

3. The charging method of claim 2, wherein generating the vehicle information data regarding the charging providing vehicle further comprises:
searching, by the charging management device, for vehicle management data;
determining, by the charging management device, whether a charging providing vehicle of a plurality of charging providing vehicles that provides the charging amount required by the battery to the charging target vehicle is located based on the vehicle management data; and
when the charging providing vehicle of the plurality of charging providing vehicles is determined to be located, generating, by the charging management device, the vehicle information data regarding the charging providing vehicle.

4. The charging method of claim 1, wherein generating the vehicle information data regarding the charging providing vehicle further comprises:
generating, by the charging management device, the vehicle information data including at least one of a vehicle type, a vehicle number, a parking location, an installation location of a charging and discharging device, charging and discharging port information, or wireless charging and discharging link information regarding the charging providing vehicle.

5. The charging method of claim 1, wherein generating the vehicle information data regarding the charging providing vehicle further comprises:
transmitting, by the charging management device, charging providing query data to a communication device of the charge providing vehicle;
receiving, by the charging management device, charging providing response data from the communication device;
checking, by the charging management device, whether an approval is included in the charge providing response data; and
generating, by the charging management device, the vehicle information data regarding the charging providing vehicle when the charging providing response data includes the approval.

6. The charging method of claim 1, wherein checking the charging result data further comprises:
receiving, by the charging management device, first charging result data including at least one of a charging amount or a charging time from the charging target vehicle; and
checking, by the charging management device, the first charging result data.

7. The charging method of claim 6, wherein checking the charging result data further comprises:
receiving, by the charging management device, second charging result data including at least one of a discharging amount or a discharging time from the charging providing vehicle; and
checking, by the charging management device, the second charging result data.

8. The charging method of claim 1, wherein generating the payment request data comprises:
generating, by the charging management device, a payment charge based on the charging result data; and
generating, by the charging management device, the payment request data including the payment charge.

9. The charging method of claim 8, wherein generating the payment charge comprises:
searching, by the charging management device, for charge data including a charging unit price; and
generating, by the charging management device, the payment charge based on the charge data and the charging result data.

10. A charging management device for an electric vehicle, comprising:
a receiver configured to receive, from a charging target vehicle, charging request data and charging result data;
an information generator configured to:
search for a charging providing vehicle sharing electric power with the charging target vehicle based on the charging request data; and
generate vehicle information data regarding the charging providing vehicle;
a controller configured to:
generate a payment charge based on the charging result data and charge data; and
generate payment request data including the payment charge; and
a transmitter configured to transmit, to the charging target vehicle, the vehicle information data and payment request data.

11. The charging management device of claim 10, wherein the information generator is further configured to:
search for vehicle management data that corresponds identification information of a vehicle and a remaining amount of a battery of the vehicle to location data of the vehicle; and
check a charging providing vehicle of a plurality of charging providing vehicle that provides a charging amount required by the battery of the charging target vehicle based on the vehicle management data.

12. The charging management device of claim 10, wherein the information generator is further configured to:
generate the vehicle information data including at least one of a vehicle type, a vehicle number, a parking location, an installation location of a charging and discharging device, charging and discharging port information, or wireless charging and discharging link information regarding the charging providing vehicle.

13. The charging management device of claim 10, wherein the controller is further configured to:
generate an identification code based on the payment charge; and
generate the payment request data including the identification code.

14. The charging management device of claim 13, wherein the identification code includes at least one of a radio frequency identification tag, a near field communication tag, a one-dimensional barcode, or a two-dimensional barcode.

15. A charging system for an electric vehicle comprising:
a charging target vehicle configured to generate charging request data including a position where the charging target vehicle is expected to park and a charging amount required by a battery of the charging target vehicle;
a charging providing vehicle configured to transmit, to the charging target vehicle, an electric power; and
a charging management device configured to:
search for the charging providing vehicle sharing the electric power with the charging target vehicle in response to the charging request data;
generate vehicle information data regarding the charging providing vehicle;
transmit, to the charging target vehicle, the vehicle information data;
generate payment request data based on charging result data; and
transmit, to the charging target vehicle, the payment request data.

16. The charging system of claim 15, wherein the charging target vehicle is configured to receive, from the charging providing vehicle, the electric power through a wired cable.

17. The charging system of claim 15, wherein a wireless charging receiver of the charging target vehicle is configured to receive the electric power from a wireless charging transmitter of the charging providing vehicle.

18. The charging system of claim 15, wherein the charging management device is configured to:
search for vehicle management data that corresponds identification information of a vehicle and a remaining amount of a battery of the vehicle to location data of the vehicle; and
check a charging providing vehicle of a plurality of charging providing vehicles that provides the charging amount required by the battery of the charging target vehicle based on the vehicle management data.

19. The charging system of claim 18, wherein the charging management device is configured to:
search for a third party vehicle providing the charging amount required by the battery of the charging target vehicle when no vehicle is searched to share the electric power with the charging target vehicle in the position where the charging target vehicle is expected to park.

20. The charging system of claim 15, wherein the charging management device is configured to:
generate a payment charge based on the charging result data including at least one of a charging amount, a charging time of the charging target vehicle, a discharging amount, or a discharging time of the charging providing vehicle; and
generate the payment request data including the payment charge.
